(19) United States
(12) Patent Application Publication
(10) Pub. No.: US 2006/0195351 A1
(43) Pub. Date: Aug. 31, 2006

(54) Internet-based system and method for leasing rental property to a prospective tenant based on criminal history

(76) Inventor: Bagrat Bayburtian, Potomac, MD (US)

Correspondence Address: SHUMAKER LOOP & KENDRICK, 101 E. KENNEDY, SUITE 2800, TAMPA, FL, 33672-0609, US

(21) Appl. No.: 11/349,457

(22) Filed: Feb. 7, 2006

Related U.S. Application Data
(60) Provisional application No. 60/650,483, filed on Feb. 7, 2005.

(51) Int. Cl. G05B 19/418; G06F 9/46

(52) U.S. Cl. 705/8

(57) ABSTRACT

System and method for landlord analysis of the suitability of a prospective tenant based on the tenant's criminal history. Landlord predetermines via web-based interface various parameters under which an “accept” or “decline” report is issued. Landlord analysis is automated and provided via web-based interface.

### PRIORITY CLAIM

This claims priority to Provisional Application Ser. No. 60/650,483, filed Feb. 7, 2005, and titled Internet-Based System And Method For Leasing Rental Property To A Potential Tenant Based On Criminal History.

### BACKGROUND OF THE INVENTION

1. Field of the Invention

The present invention relates system service and method for leasing rental property to a potential tenant.

2. Background

Landlords must frequently evaluate whether to rent their properties to prospective tenants. This process is difficult, since many prospective tenants are not who they appear to be on the surface. That is, many prospective tenants may come across as friendly, law-abiding, and responsible citizens. Yet when scrutinized carefully, some prospective tenants hide pernicious and loathsome criminal backgrounds. Indeed, such backgrounds may be strong indicators of how a prospective tenant might treat a rental property and, just as important, whether a prospective tenant is likely to meet payment obligations to the landlord.

Uncertainty as to a prospective tenants background has led to the development of various systems for performing background checks on prospective tenants. Indeed, the use of computer systems and methods for qualifying candidates, and in particular, a prospective tenant is known in the prior art. By way of example, U.S. patent application Ser. No. 09/852,867 published Nov. 14, 2002 relates to a method of qualifying a renter. U.S. patent application Ser. No. 10/242,150, published Mar. 20, 2003, relates to a system and method for identity validation for a regulated transaction. U.S. patent application Ser. No. 10/079,050 published Aug. 28, 2003 relates to a method and system for a data service to control access to personal information. U.S. patent application Ser. No. 10/285,750 published May 6, 2004 relates to an interactive, certified background check business method. U.S. patent application Ser. No. 10/699,724 published Sep. 23, 2003 relates to an internet-based system of employment referencing and employment history verification for the creation of a human capital database. U.S. patent application Ser. No. 10/813,915 published Dec. 9, 2004 relates to a suspicious persons database.

The foregoing references, however, have certain drawbacks and limitations. In particular, with presently available systems, it is excessively difficult or impossible to quickly and efficiently ascertain whether an applicant for a rental property has a criminal background. Such a check may require manually reviewing and analyzing a candidate's criminal background, which may not be entirely clear to a landlord. Moreover, current systems also lack a method of deciding whether prospective tenant presents a acceptable risk in view of their criminal background.

Therefore, it can be appreciated that there exists a continuing need for a new and improved method for leasing rental property to a potential tenant based on a prospective tenant's criminal history.

### BRIEF SUMMARY

It is therefore an object of the present invention to resolve or improve upon one or more of the above described drawbacks. This object is obtained by providing a system and method, facilitated by an Internet-based interface, of analyzing and managing tenant selection decisions. In general, the present disclosure describes a system and method of automating leasing decisions. This relieves landlords, management companies, and their staffs of the burden of interpreting criminal search results. It also ensures consistency in the decision process. In general, the landlord sets the policies or parameters for accepting or declining categories of criminal offenses. Then, criminal record search results are evaluated, and an accept/decline leasing decision is delivered to the landlord.

In general, the present invention includes an automated and efficient method for a landlord to determine whether to accept or decline a prospective tenant based on the tenant's criminal history. The method includes maintaining an interactive web-site where a landlord can predetermine setup parameters and fill in request forms. The setup parameters may include, for example, an offense type, an offense level and disposition of a criminal offense, and an offense age.

In one embodiment, the method further includes providing a criminal history information database including criminal records of prospective tenants. The criminal records include information about offense type, offense level and disposition, and offense age. In addition, the method includes searching for and locating records in the database by inputting the identification information for the tenant. Once a record is located in the database, the record is compared to the predetermined setup parameters. This can generate an accept decision or a decline decision, depending on the parameters that are predetermined by the landlord.

For a better understanding of the invention and operating advantages attained by its users, reference should be made to the accompanying drawings and descriptive matter in which there is illustrated an embodiment of the invention.

### BRIEF DESCRIPTION OF THE DRAWINGS

The invention will be better understood when consideration is given to the following detailed description thereof. Such description makes reference to the annexed drawings wherein:

FIG. 1 illustrates a method for leasing rental property to a potential tenant based on criminal history; and

FIGS. 2a, 2b, 2c and 2d represent a set-up matrix or parameters for allowing landlord/property management companies to determine acceptable levels of tenant criminal history.

The same reference numerals refer to the same parts throughout the various figures.

### DESCRIPTION OF THE PREFERRED EMBODIMENT

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings. It should also be understood that the drawings are not to scale and in certain instances details have been omitted, which are not necessary for an understanding of the present invention, such as conventional programming details that are apparent to one of ordinary skill in the art.

Definitions:

Offense Type: in general terms, the type of crime (e.g., stealing is an Offense Against Property).

Offense Level and Disposition: the severity of the crime (e.g., felony or misdemeanor) and the result of the legal process (e.g. arrest or conviction).

Felony Convictions Only: does not include any misdemeanors or felony arrest records.

Any Felony Charges: includes felony convictions, arrests, indictments, but does not include misdemeanors.

All Convictions: includes misdemeanor and felony convictions.

Any Criminal Charge: includes misdemeanor and felony convictions, arrests, warrants, and unprosecuted actions.

Offense Age: the length of time since the date of the offense. The age of the offense is generally determined by the disposition date. If a disposition date is not provided or otherwise available, the sentence date, custody date or arrest date will be used, in that order of availability, to determine the age of the offense.

Criminal History Information Database: a database having records of individuals that have any criminal charge.

The present disclosure relates to an internet-based computer system and method for leasing rental property to a potential tenant based on criminal history. The components of system 10 generally include a rental request 14, router 18, a database 28, setup parameters 94, and a queue system 64.

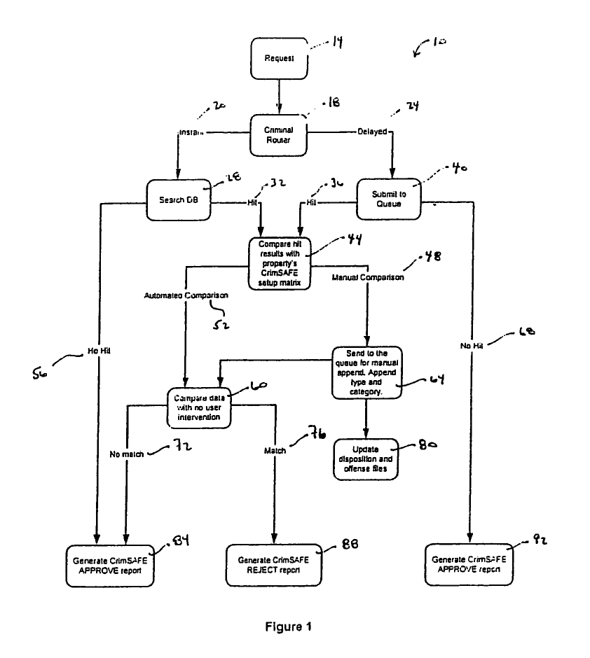

Referring to the figures, FIG. 1 illustrates a flow diagram of an internet-based computer system and method 10 for making decisions relating to the leasing of rental property to potential tenants based on criminal history. The system 10 includes, a conventional router 18 that allows access to criminal history databases 28 via the Internet capabilities.

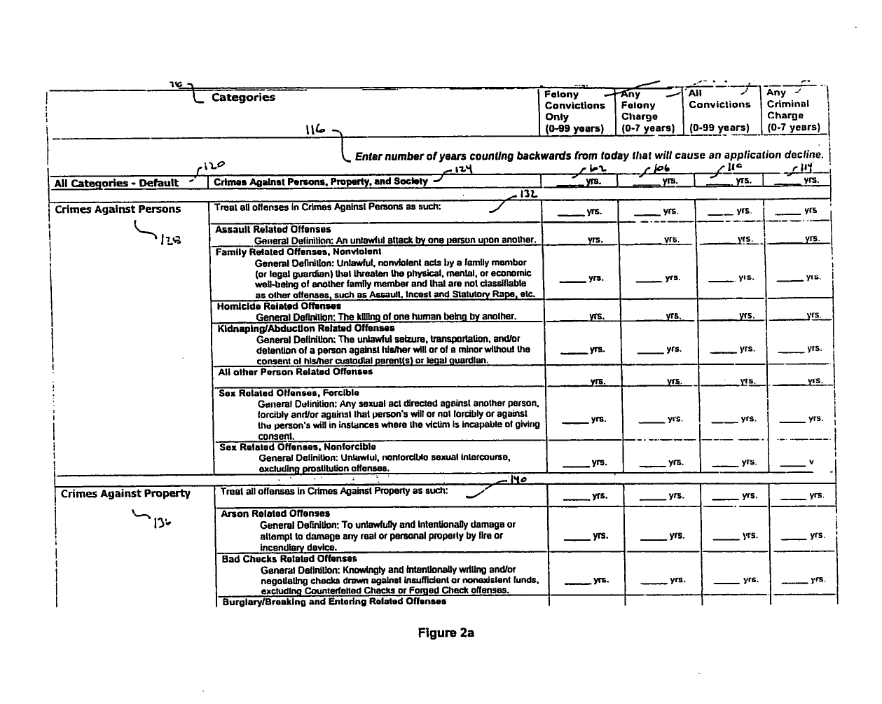

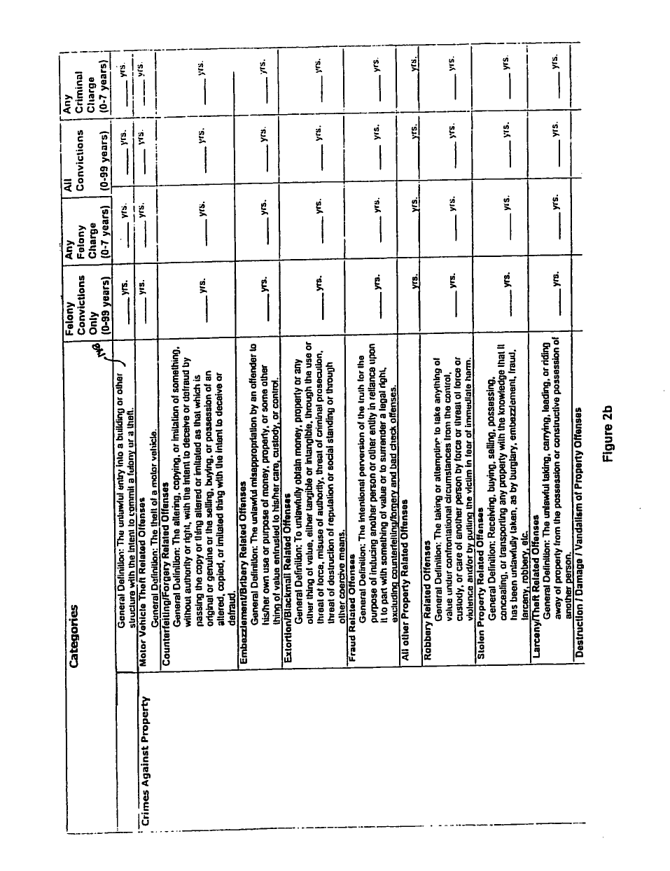

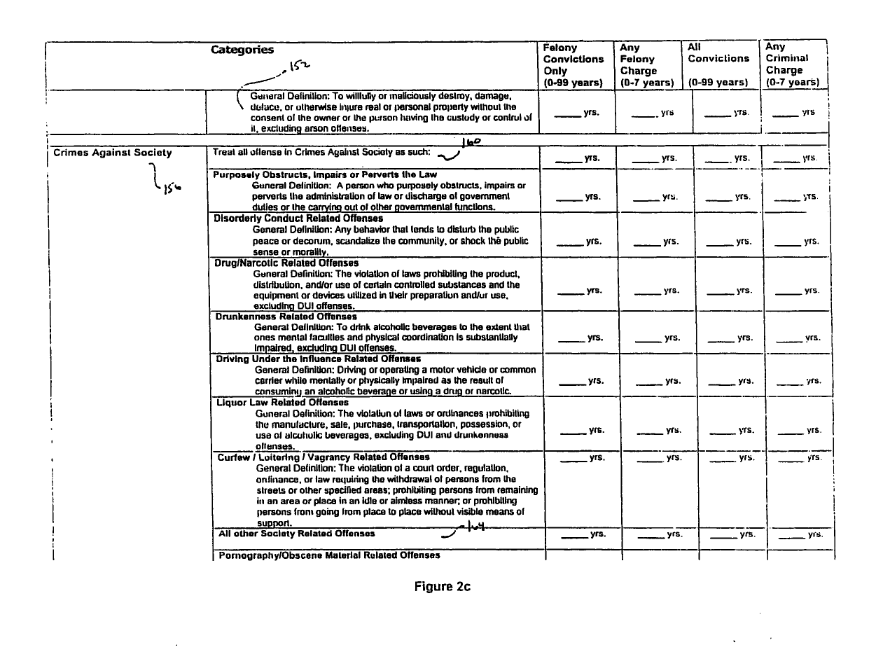

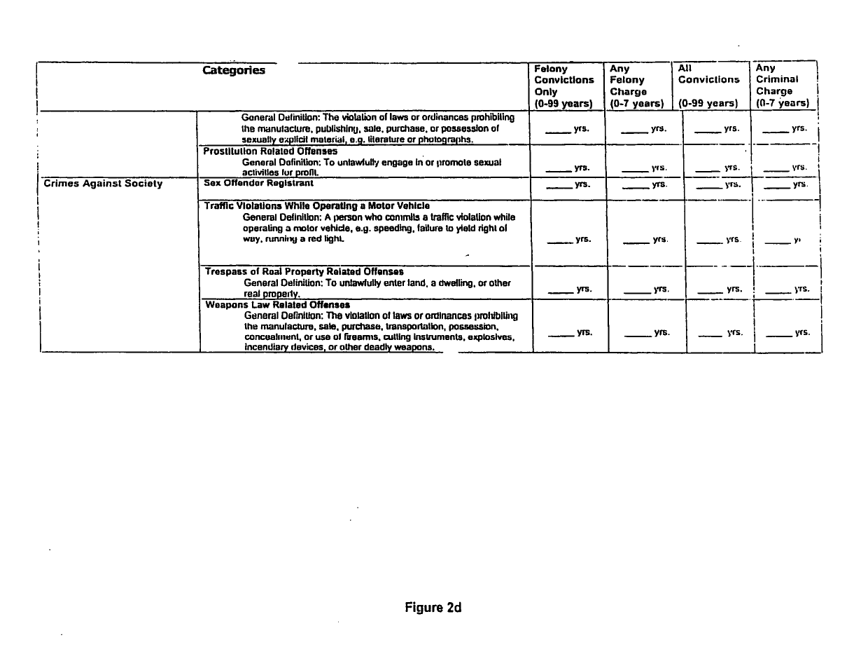

FIGS. 2a-2d illustrate setup parameters 94. An interactive web-site is provided for a user to easily predetermine or setup parameters 94. Each of the setup parameters 94 is based upon criminal offense type 128, 136, 156, offense levels and disposition 100, 104, 108, and 112, and the length of time 102, 106, 110, 114 since the date of the offense. A landlord can configure the parameters 94 to include a specific type of criminal offense, a level and disposition of that criminal offense, and the length of time since the occurrence of that criminal offense. Based on the landlord-specified parameters, a prospective tenant's criminal background can be analyzed and accepted or declined based on the prospective tenant's criminal background (if any). That is, parameters 94 are used as the threshold for automatically accepting or declining a rental decision landlord and property.

Depending on a landlord's policy, parameters 94 can be setup to use the same configuration regardless of criminal offense types, to use different configurations for each individual criminal offense type, or to use the same configuration overall with the exception of one or two individual offense types which are configured to override the general (default) configuration. Stated differently, the parameters can be tailored as needed by the landlord.

For example, a landlord can select all categories as a default 120 (FIG. 2a). This category includes crimes against persons, property, and society 124 in any search. Once this setting is determined by the landlord, the landlord can select the result of the criminal offense that the landlord deems unacceptable, i.e. on which would result in a “decline” response. In particular, the landlord can select from criminal offenses that resulted in felony convictions 100, any felony charge 104, all convictions 108, and any criminal charge 112. If a landlord selects a particular criminal offense that results in one of these outcomes, then the landlord my select the age of the offense that will result in a decline report. For example, if a landlord chooses to decline for felony offenses that are less than 10 years old, then any candidate with a felony on their record that is less than 10 years old will be declined. In addition, if a landlord wishes to decline a prospective candidate based on an offense, regardless of the age of the offense, the landlord can input the number 99 for the particular result. Alternatively, if a landlord is willing to accept a particular offense under the default 120, then the landlord can input the number 0 for the particular result.

Alternatively, the landlord can select either crimes against persons 128, crimes against property 136 or crimes against society 156. This allows the landlord to more precisely tailor the categories to the landlord's needs for a particular property or group of properties. To tailor the parameters 94 even more precisely, the landlord can select specific crimes that will result in a decline report. For example, the landlord can select assault,,family, homicide, kidnapping, or sex-related offenses as the specific parameters for accepting or declining a prospective tenant.

Moreover, as desired by a landlord, the setup parameters 94 can be configured identically for all rental properties or can be tailored to different rental properties. The setup parameters 94 are operatively coupled with the router 18 as will become apparent to one of ordinary skill in the art in view of the present disclosure.

Database 28 is an internet accessible comprehensive database of crimes and offenses. Database 28 is configured to allow real-time additions to and deletions of data within the database 28 as well as real time interrogation of and access to the data within the database. The database's comprehensive collection of crimes or offenses is categorized in terms of crime or offense frequency. In doing so, the database covers 75% of reportable hits. To cover the remaining 25% of reportable hits, a manual categorization process is utilized. In effect, uncategorized hits end up in a queue for manual processing. Therefore, system users get consistent results even if a particular offense has not yet been categorized. The invention also includes a self-learning system that keeps track of manual categorizations, and once it reaches a certain threshold, it appends the categorization to a master table.

In the event of a search result including a crime or offense which has not already been categorized, e.g., because it is an infrequent crime, the queue system 64 is utilized, as illustrated in FIG. 1. Once this new hit goes through the queue system and is categorized, the system is self-learning. In the future, the system recalls the previous categorization of that particular offense. That is, once an offense is categorized a particular way, offense is appended to the database. The system thus remembers how the crime or offense was categorized previously and appends to the database so that the next time, the same, consistent result is produced. In particular, an update instruction 80 is generated to update the database accordingly. This is the self-learning component of the present invention.

There is also a conflict resolution component of the present invention. If for some reason a particular offense has not been categorized, and then when going through the queue process the offense gets categorized one way, and later, the offense gets categorized another way, then such inconsistency can be manually resolved. A determination is made as to why it was categorized one way one time and another way another time, and a note is made to categorize it properly in the future. This is called a manual intervention system.

A rental request 14 can be used to gather information from each potential tenant. Each request 14 includes the potential tenant's name, address, social security number, date of birth and related information. Each request 14 may also include and specify any potential rental properties that the prospective tenant is considering, as described in greater detail above.

The present disclosure further includes a method of utilizing the system described herein. That is, the present disclosure also includes a method for making decisions relating to the leasing of rental property to prospective tenants based on their criminal history.

As illustrated in FIG. 1, one step includes providing a router allowing access to a criminal history database that derives information from one or more sources. The router has internet capabilities to allow real time additions to and deletions of data within the databases as well as real time interrogation and access of the data within the databases.

Another step includes providing setup parameters (e.g., parameters 94 illustrated in FIGS. 2a-2d) that can be accessed, edited, and submitted via the Internet. The setup parameters can be tailored to each property to be leased prior to submitting a request. Alternatively, a single set of setup parameters can be used for all properties relevant to a landlord. As discussed above, the setup parameters are based upon criminal offense type, offense level and disposition, the result of the legal process, and the length of time since the date of the offense. These parameters are set as a threshold by a landlord for accepting or declining to lease property to a prospective tenant.

Another step includes providing a rental request (e.g., request 14) for each potential tenant. The rental request can include information such as prospective tenant's name, address, social security number, date of birth or other related identification and background information. The request can also include currently available property listings. A prospective candidate can thus indicate on the rental request the property or properties in which the tenant is interested. The rental request is adapted to be input into the router. Once a request is input into the router, depending on the preference of the landlord, an instant search can be performed or a delayed search can be performed.

As illustrated in FIG. 1, if an instant search is requested, a search is performed of the criminal history database 28 to identify any relevant criminal history information for the particular candidate. If the search results in no hits, i.e., no records are found in the database, then an accept report is automatically generated. On the other hand, if a criminal record is located for the prospective tenant, then the criminal record is compared to the setup parameters that are predetermined by the landlord. If the criminal history violates a landlord's predetermined parameters, then a reject report is generated.

If an instant search is not requested, the request is passed from the router to a queue. The delayed request then advances through the queue to the database. As above, if there is no hits for the request in the database, then an “accept” report is automatically generated. On the other hand, if a criminal record is located for the prospective tenant, then the criminal record is compared to the setup parameters that are predetermined by the landlord. If the criminal history violates a landlord's predetermined parameters, then a “reject” report is generated.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

It is intended that the foregoing detailed description be regarded as illustrative rather than limiting, and that it be understood that it is the following claims, including all equivalents, that are intended to define the spirit and scope of this invention.

What is claimed is:

1. A method for landlord analysis of the suitability of leasing property to a prospective tenant based on the tenant's criminal history, comprising the steps of:
a) obtaining identification information for the tenant;
b) maintaining an interactive web-site for a landlord to predetermine setup parameters;
c) predetermining the setup parameters;
d) providing a criminal history information database comprising criminal records of candidates;
e) searching for and locating a record in the database by inputting the identification information for the tenant; and
f) comparing the record to the predetermined setup parameters.

2. The method of claim 1, wherein the setup parameters are selected from the group consisting of an offense type, an offense level and disposition of a criminal offense, and an offense age.

3. The method of claim 2, wherein the criminal records comprise information selected from the group consisting of a specific type of criminal offense, a level and disposition of a criminal offense, and a length of time elapsed since the occurrence of a criminal offense.

4. The method of claim 3, further comprising the step of:
g) generating an accept decision based on step f), whereby the landlord does not lease the property to the prospective tenant.

5. The method of claim 3, further comprising the step of:
g) generating a decline decision based on step f), whereby the landlord does not lease the property to the prospective tenant.

6. The method of claim 2, further comprising the step of:
g) generating one of an accept decision and a decline decision based on step f.

7. The method of claim 1, wherein the database is accessible via the interactive web-site.

8. A method for analyzing the suitability of a candidate for a position, comprising the steps of:
a) providing a:
a request form;
setup parameters; and
a computer system, comprising
a router adapted to receive the request form; and
a search database operatively connected to the router,
the search database comprising criminal history information;
b) gathering the candidate's identification information;
c) inputting the candidate's identification information into the request form;
d) searching the database for criminal history information related to the candidate;
e) comparing the criminal history information to setup parameters; and
f) generating one of an accept decision and a decline decision based on the results of the comparison of step e).

9. The method of claim 8, wherein the request form is accessible via an interactive web-site.

10. The method of claim 9, wherein the setup parameters are accessible via an interactive web-site.

11. The method of claim 9, wherein steps e) and f) are performed manually.

12. The method of claim 9, wherein steps e) and f) are performed automatically by the computer system.

13. A method for landlord analysis of the suitability of a prospective tenant based on the tenant's criminal history, comprising the steps of:
a) obtaining identification information for the tenant;
b) maintaining an interactive web-site for a landlord to predetermine setup parameters, the setup parameters being selected from the group consisting of an offense type, an offense level and disposition, and an offense age;
c) predetermining the setup parameters;
d) providing a criminal history information database comprising criminal records of candidates, the criminal records including information selected from the group consisting of an offense type, an offense level and disposition, and an offense age;
e) searching for and locating a record in the database by inputting the identification information for the tenant;
f) comparing the record to the predetermined setup parameters;
g) generating one of an accept decision and a decline decision based on step f).
